(19) United States
(12) Patent Application Publication
(10) Pub. No.: US 2018/0164840 A1
(43) Pub. Date: Jun. 14, 2018

(54) CONTROL DEVICE AND METHOD FOR REMOTE CONTROLLING AN AIR CONDITIONING SYSTEM

(71) Applicant: TADO GmbH, Munchen (DE)

(72) Inventors: Johannes Schwarz, Munchen (DE); Tobias Schneider, Munchen (DE)

(73) Assignee: TADO GMBH, Munchen (DE)

(21) Appl. No.: 15/325,110

(22) PCT Filed: Jul. 10, 2015
(86) PCT No.: PCT/EP2005/001416

§ 371 Date: Oct. 6, 2017

(30) Foreign Application Priority Data
Jul. 10, 2014 (DE) 102014009414.6

(51) Int. Cl. G05D 23/19; F24F 11/72; H04W 4/021; H04W 64/00

(52) U.S. Cl. CPC G05D 23/19; H04W 64/003; H04W 4/021; F24F 11/72

(57) ABSTRACT

A control apparatus for the remote control of an air conditioning system comprises a sending device for sending an air conditioning system command, electronic signal receiving means for receiving instructions for the air conditioning system and electronic control and evaluation means, which are designed, as a function of received instructions for the air conditioning system control to trigger the sending device to send an air conditioning system control command. According to the invention measuring means for determining at least one ambient property are provided and the control and evaluation means are designed, using measured values of the measuring means, to evaluate whether, after sending of an air conditioning control command, a change in the measured ambient property has arisen, and to resend a heating and/or air condition system control command if the evaluation shows that no change has arisen in the measured ambient property.

### TECHNICAL FIELD

The present invention relates to a control apparatus for remote control of an air conditioning system according to the introductory part of claim 1 and to a method for remote control of an air conditioning system according to the preamble of claim 15.

### BACKGROUND

Air conditioning systems are controlled in most cases by simple remote controls (remote operations). A user activates a key on these remote controls, following which the remote control sends an air conditioning system control command to the air conditioning system. The air conditioning system control command (hereinafter: AC control command) is often an infrared signal. The user is in visual contact with the air conditioning system so that the air conditioning system can receive the signal that has been sent.

A problem with this simple type of control is that an air conditioning system is often unnecessarily switched on or cools down to an unnecessary extent. This is the case for example if a user forgets to switch off the air conditioning system. In addition a pre-cooled room is preferred by many users, for which purpose an air conditioning system is intentionally left switched on when leaving the room.

These problems are addressed in generic control apparatuses for remote control of an air conditioning system. Such a control apparatus comprises a sending device for sending an AC control command, electronic signal receiving means (electronic device for receiving signals) for receiving instructions for the air conditioning system control and electronic control and evaluation means (electronic control and evaluation device) which is configured, in dependence on instructions received for the air conditioning system control, to trigger the sending device to send an AC control command.

Correspondingly, in a generic method for remote control of an air conditioning system it is provided that:
a sending device of a control apparatus sends an AC control command,
electronic signal receiving means of the control apparatus receive instructions for the air conditioning system control, and
electronic control and evaluation means of the control apparatus, in dependence on instructions received for the heating/and or air conditioning system control, trigger the sending device to send an AC control command.

The signal receiving means make it possible for the user to be absent from the room of the air conditioning system and to still be able to control it. It is thereby made possible for example to switch off the air conditioning system from a remote location if this has been forgotten when leaving the room of the air conditioning system.

In conventional control apparatuses, however, it is disadvantageous that either operating expense for the user is high, in order to carry out a control remotely, or, in the case of a further automated control, control errors arise, as a result of which an undesirably great or also an undesirably tenuous cooling is brought about. The risk of such control errors is marked particularly in the case of later incorporation or retrofits, wherein an (often older) air conditioning system of a different manufacturer is controlled with a control apparatus.

### Technical Object

It can be regarded as an object of the invention to provide a control apparatus and a method that control an air conditioning system particularly reliably with little effort from the user.

### BRIEF DESCRIPTION OF THE INVENTION

This object is achieved by means of the control apparatus having the features of claim 1 and the method having the features of claim 15.

Preferred embodiments are indicated in the dependent claims and in the description below.

In the control apparatus of the abovementioned type, according to the invention measuring means are provided to determine at least one ambient property. In addition the control and evaluation means are further configured to evaluate, using measured values (measurement values) of the measuring means, whether, after an air conditioning system control command (AC control command) has been sent, a change in the measured ambient property has arisen, and to resend an AC control command if the evaluation indicates that no change has arisen in the measured ambient property.

In the method of the previously mentioned type it is provided according to the invention that measuring means of the control apparatus determine at least one ambient property. The control and evaluation means evaluate, using measured values of the measuring means, whether, after an AC control command has been sent, a change has arisen in the measured ambient property. If the evaluation indicates that no change has arisen in the measured ambient property, the control and evaluation means again trigger the sending of an AC control command.

It can be regarded as an essential idea of the invention to check whether an AC control command sent has also actually been received by the air conditioning system (heating and/or air conditioning system). This reduces the risk, due to a failed transmission, of a different operating state of the air conditioning system being assumed with respect to that which is actually the case. Failed transmission can arise for example if obstacles, for example furniture or other objects, are placed in the transmission path between the control apparatus and the air conditioning system.

The advantages of the invention are particularly evident if the air conditioning system does not provide command receipt confirmations, i.e. it does not send back an own signal. This leads to uncertainty of the current operating state.

In addition there are air conditioning systems that interpret a certain AC control command differently in dependence on their current state. For example, one and the same AC control command may be provided for switching on and switching off. Also, a progressive turning-up of the cooling output can be realised due to the same AC control command being received multiple times. In these cases, a desired operating state cannot be reliably set if just one AC control command is sent. Instead, a measurement of an ambient property must additionally be realised. Through the measurement, a current operating state and/or a change of the operating state of the air conditioning system is/are detected.

The advantages of the invention are also particularly significant if a user is additionally using a conventional remote control for the air conditioning system control. In this case it is not possible, or it is hardly possible, to infer a current operating state solely from the AC control commands of the control apparatus sent. Instead, it must also be possible to detect a change caused by a conventional remote control.

This is realised according to the invention by measuring means determining an ambient property. The ambient property can in principle be any measurable variable, or parameter, that is changed by the air conditioning system. If a change in this ambient property is determined it is inferred that the AC control command sent has been successfully received and implemented. If on the other hand no change is determined, the conclusion is drawn that the AC control command sent was not received by the air conditioning system. As a result, the AC control command is re-sent and it is again checked whether a change then arises in the ambient property.

It can usefully be specified through predefined threshold values that minor fluctuations in the ambient property are not to be evaluated as a change in the ambient property.

The measuring means/device (or detection means) can be configured to detect as ambient properties: an ambient temperature and/or ambient sounds and/or relative air humidity. These ambient properties are changed when there is a change of operating mode of the air conditioning system. An air conditioning system thus causes different ambient sounds in dependence on its operating state. In addition it brings about not only a change in the ambient temperature but also, in association therewith, a change in the relative air humidity.

Ambient sound can include the sounds caused by the cooling operation of the air conditioning system, essentially ventilation or humming noises, wherein, in dependence on the model of air conditioning system, the receipt of an AC control command is confirmed by the output of a beep. The beep can also be detected and evaluated as ambient sound.

Comparison values can be predefined for each ambient property in order to evaluate whether a change in the ambient property has been detected. The comparison values can include for example reference beeps or reference humming noise(s). In the case of an ambient temperature being measured, a temperature change relative to a measured temperature before the AC control command was sent can be used as an evaluation criterion.

Different detection and evaluation periods can be predefined for different ambient properties detected or measured. For example, a detected beep can only be evaluated as an ambient property change, i.e. as coming from the air conditioning system, if it is detected at the latest two seconds after the AC control command was sent. For measuring the ambient temperature on the other hand, a longer measurement period is used, which can end for example between one and ten minutes after the AC control command has been sent.

Preferably, not only reference values, but also differences from previous measured values are used to evaluate whether an ambient property change has arisen. The control and evaluation means can furthermore be configured:
upon receiving an instruction for the air conditioning system control, to firstly determine measured values of an ambient property with the measuring means,
to subsequently send an AC control command with the sending means,
to then re-determine measured values of the ambient property with the measuring means, and
using the measured values that have been recorded before and after sending of the AC control command, to carry out the evaluation whether a change in the measured ambient property has occurred after an AC control command has been sent.

It is hereby possible for example to avoid ambient sounds that are independent from the air conditioning system distorting the evaluation, for example traffic noise, which is measured both before and also after the AC control command is sent.

In dependence on the ambient property to be measured or detected, the abovementioned first measurement of the ambient property and the subsequent sending of an AC control command can also be interchanged. This may be useful if the ambient property is not changed quickly by the air conditioning system. For example, a temperature change as a result of a change of operating mode of the air conditioning system will generally not yet be detectable within a few seconds after this change of operating mode.

Depending on the air conditioning system and field of use, the ambient properties and the changes in the ambient properties can greatly differ as a result of an operating mode change of the air conditioning system. For example, depending on the air conditioning system, different beeps, or no beeps at all, are output after an AC control command has been received. The time duration, after which a temperature change can be measured, or the temperature change rate, depend essentially on the distance at which the control apparatus for the air conditioning system is assembled.

The control and evaluation means are therefore preferably configured to provide a teaching mode/teach-in mode, in which an ambient property is measured with the measuring means before an AC control command is sent and also after the AC control command has been sent, and to use measured values of the ambient property from the teaching mode in a normal mode in the evaluation of whether a change has arisen in the measured ambient property after an AC control command has been sent.

The sending device for sending an AC control command is designed so that it can emit signals that can be identified by air conditioning systems as a control command. These can be infrared signals and/or radio signals, for example in the MHz or GHz range. In the case of infrared signals it is necessary to send in the direction of the air conditioning system. In order to allow, during the assembly of the control apparatus, the orientation thereof relative to the air conditioning system to be extensively ignored, the sending device can comprise a plurality of infrared senders that radiate in different directions.

The signal receiving means can include internet communication means in order to receive instructions for the air conditioning system control. The internet communication means can for example have WLAN/WiFi communication means and/or mobile radio communication means.

Alternatively or additionally, the signal receiving means can also be configured for a direct radio communication with a smartphone, in particular by means of Bluetooth® or Bluetooth® Low Energy.

The instruction received for the air conditioning system control can be an instruction that indicates a certain air conditioning system operating state, for example an instruction to switch on or to switch off. However, the instruction can also include other information, from which the control and evaluation means can derive an AC control command according to predefined criteria.

This information can be for example a reference temperature or location information of a person, for example a smartphone user.

Through the signal receiving means, an air conditioning system can therefore already be activated before a user is in direct proximity to the air conditioning system.

In a further variant of the invention the control and evaluation means are also configured to determine, using the measured values of the measuring means, an operating state of the air conditioning system. It is therefore not only checked whether an AC control command sent has been received by the air conditioning system. The operating mode at that moment is also ascertained. This is particularly significant in order to detect when a user changes the operating state of the air conditioning system by means of a conventional remote control.

Communication means can be provided and configured to transmit a determined operating state over a network, in particular over the internet. The communication means and the signal receiving means can be formed by the same technical components. The detected operating state can be transmitted to a smartphone, which also sends instructions for the air conditioning system control to the control apparatus. Alternatively or additionally, transmission to an internet server is possible, i.e. a network-compatible computer that sends instructions for the air conditioning system control to the control apparatus. This server can also be used to receive instructions for the air conditioning system control from the smartphone and to forward them to the control apparatus, or to receive other information from the smartphone and, in dependence thereon, send an instruction for the air conditioning system control to the control apparatus.

A user should be able to recognise as quickly as possible an interference state, in which no AC control command can be successfully sent to the air conditioning system. It is thus advantageous if an interference state is automatically detected and then reported over a network to the user's smartphone. This can arise for example if furniture or other objects are blocking the signal transmission path from the control apparatus to the air conditioning system, if there is a technical defect in the control apparatus or the air conditioning system, or if the air conditioning system is not ready for operation for any other reason. The control and evaluation means can be configured to transmit, with (the) communication means, a transmission error message over a network if a change in the ambient property is still not determined after repeatedly sending the same AC control command, in particular after one or multiple unsuccessful repetitions. The transmission error message is preferably forwarded over the network to a smartphone.

The control and evaluation means can additionally be configured, after an AC control command has been sent, to perform a checking process in order to determine whether a user is actually present in proximity to the air conditioning system. In the checking process, the measuring means, or detection means, record ambient sound, which is then analysed by the control and evaluation means, in order to establish whether it contains sounds caused by the user. A further AC control command, through which the most recently sent, i.e. the last sent, AC control command is reversed, is sent depending on whether sounds caused by the user are ascertained.

If the last sent AC control command serves to activate or turn up the air conditioning system, the further AC control command is subsequently preferably sent when no sound caused by the user is established.

If on the other hand the last sent AC control command serves to deactivate or turn down the air conditioning system, the further AC control command is subsequently sent preferably precisely when sound caused by the user is ascertained.

Alternatively or additionally to the measurement or detection of ambient sound, the measuring means can also comprise a motion sensor, with which movements of the user can be detected. If the checking process includes a plurality of such measurement methods, the last sent AC control command is only cancelled when the presence of a user is not inferred by any of the measurement methods.

The checking process can be carried out in particular at a time of between 5 or 10 seconds and 5 minutes after sending of the AC control command to activate or turn up the air conditioning system.

Alternatively or additionally, the control and evaluation means can also be configured so that, before sending an AC control command, they perform a checking process to establish whether a user is actually in proximity to the air conditioning system. In the checking process, the measuring or detection means record ambient sound, which is then analysed by the control and evaluation means, in order to establish whether it contains sounds caused by the user. The AC control command is sent in dependence on whether sounds caused by the user are ascertained. It is thus possible to prevent an AC control command being sent based on an erroneously assumed position of the user.

If for example the air conditioning system is to be activated or turned up by means of the AC control command, this AC control command is preferably only sent when sounds caused by the user are ascertained.

If on the other hand the AC control command is to deactivate or turn down the air conditioning system, this AC control command is preferably only sent when no sounds caused by the user are ascertained.

The invention also comprises a system for the remote control of an air conditioning system having a control apparatus according to the invention, which can be designed as set out in this description. The control apparatus has a radio device for sending a radio signal. The system further comprises program code, which is stored on a data carrier that is readable by a smartphone, and which is designed, when run on a smartphone, to:
to analyse a radio signal sent by the radio device and received by the smartphone and thus determine location information of the smartphone relative to the control apparatus, and,
depending on the location information, to send an instruction for the air conditioning system control to the control apparatus, i.e. to trigger corresponding hardware of the smartphone to send the instruction.

A significant advantage of this variant is that the air conditioning system control is realised in dependence on the location of a user relative to the air conditioning system. In particular the control can be realised in dependence on the distance of the user from the air conditioning system, i.e. specifically in dependence on the measured distance between the user's smartphone and the control apparatus. In this way it can be particularly reliably ensured that the air conditioning system is not operated for an unnecessarily long time or at an unnecessarily high power.

Location information can be information on the location of the smartphone relative to the control apparatus and possibly relative to a further sending location, from which radio signals that can be evaluated are sent. Alternatively or additionally, the location information can also be distance information, which indicates the distance of the smartphone from the control apparatus. In the exemplary embodiments below, wherein reference is made to the distance, this can be understood more generally to also include the location or location information.

The radio signal, from which location information is obtained, can be for example in the range of between 1 and 10 GHz, preferably in the 2.4 GHz range. It can be provided that the radio device of the control apparatus and/or the hardware of the smartphone can perform the functions of Bluetooth® Low Energy or iBeacon®. The radio signal can be analysed with respect to its signal strength and/or with respect to other properties, in order to carry out the distance determination.

The instruction for the air conditioning system control can be sent directly from the smartphone to the control apparatus. Alternatively, this instruction can be sent over a network or internet connection to a server, i.e. a network-compatible computer. The server then forwards, in dependence on the received instruction, an instruction or this same instruction to the control apparatus. The instruction sent by the smartphone accordingly does not necessarily have to be an instruction that can be read by the control apparatus. Instead, this instruction can also be understood as location information of the smartphone (or in principle any other desired information), from which an instruction for the air conditioning system control is then generated by the network server and sent to the control apparatus.

A “smartphone” can be understood to be any computing device that can be carried by a person and can establish network connections and in particular is also capable of mobile radio telephony. A tablet computer can also be interpreted as a smartphone in this sense.

The data carrier with program code for the smartphone can be located in principle at any location and be read in any way by the smartphone. For example it can be provided that the data carrier is a memory of a network server and the smartphone loads the program code of the data carrier over a network connection onto an internal memory of the smartphone, in order to then execute the program code. During operation the program code executed by the smartphone can also interact with further program code of a network server in order to carry out the functions described here.

To determine location information, the signal strength of a wireless network can additionally also be used. This network can be for example a WLAN/WiFi network, via which the communication means of the control apparatus can also establish an internet connection. If the smartphone is in proximity to the control apparatus, both are at a similar distance from a router or another device that makes up the network. If on the other hand for example the smartphone and the router are in the same room, but in a different room from the control apparatus, this can be differentiated from the aforementioned case through a comparison of the signal strengths.

In this embodiment, a signal strength of a network can be detected with the communication means of the control apparatus, and the program code is designed, when run on a smartphone, to cause the smartphone to detect a signal strength of the network. A determination of the location information of the smartphone relative to the control apparatus is realised not only through the analysis of the radio signal described above, but instead additionally also through evaluation means, which are configured, through a comparison of the signal strength detected with the communication means of the control apparatus and the signal strength detected by the smartphone, to estimate a distance between them. The evaluation means can be part of the control and evaluation means of the control apparatus, part of the program code for the smartphone and/or hardware and/or software on a network server.

The program code can also be designed to provide a teaching mode, in which the user can allow the smartphone to determine the signal strength at different locations and inputs the respective location information in each case.

An air conditioning system should allow control as far as possible corresponding to the individual wishes of a user and which is nonetheless automatic. For this, it is advantageous if a user can input a certain control behaviour in a teaching mode. For this, the program code can provide a location teaching mode and a normal mode. In the location teaching mode a smartphone user is given the opportunity, at different locations, to:
(a) trigger the program code to perform a localization at the respective location and store location information recorded in this way, and
(b) indicate at the respective location which type of instruction for the air conditioning system control is to be sent from the smartphone to the control apparatus.

In normal mode an analysis of a radio signal is carried out to determine momentary location information of the smartphone by determining matches with the recorded distance data from the location teaching mode. The type of instruction for the air conditioning system control that has been stored in the location teaching mode for the matching location information is sent to the control apparatus.

In this way, for example different locations, at which similar signals are received in normal mode, can be better differentiated. In particular it can be better differentiated whether a user is in an adjacent room to the air conditioning system or in the same room but at a fairly long distance.

Air conditioning systems of different manufacturers can also differ in the required AC control command for a certain operating state, for example for switching off. Nevertheless the same sending device must be usable independently of the air conditioning system present in the respective application. A data memory can thus be provided, in which different sets of AC control commands are stored to control different types of air conditioning systems. The program code can provide a control command selection mode, in which a user can select a certain set. Alternatively, a suitable set can be determined. For this, it is made possible in the control command selection mode for a user to trigger sending of AC control commands of different sets. After sending of each of the AC control commands the user can input via the smartphone and/or the measuring means can determine by measuring the ambient property whether an operating state of the air conditioning system has changed corresponding to the AC control command sent.

The data memory with the different sets of AC control commands can be provided for example in the control apparatus and/or in a network server, whereby extending the sets to include commands for new air conditioning systems is easily possible.

The program code can also be designed to trigger, in the checking process, in which an actual proximity of the user to the air conditioning system is checked, a microphone of the smartphone to record ambient sound. To check the proximity of the user to the air conditioning system, the program code then determines matches between the ambient sounds recorded by the smartphone and ambient sounds recorded by the measuring means.

The properties of the invention described as additional apparatus features are also to be interpreted as variants of the method according to the invention and vice versa. In particular, method variants follow from the proper operation of the control apparatus and its control and evaluation means.

Further advantages and features of the invention are described below with reference to the appended drawing.

### BRIEF DESCRIPTION OF THE DRAWING

FIG. 1 shows, schematically, a room, in which an air conditioning system and a control apparatus according to the invention for the air conditioning system are located, as well as an adjacent room.

### DETAILED DESCRIPTION OF THE DRAWING

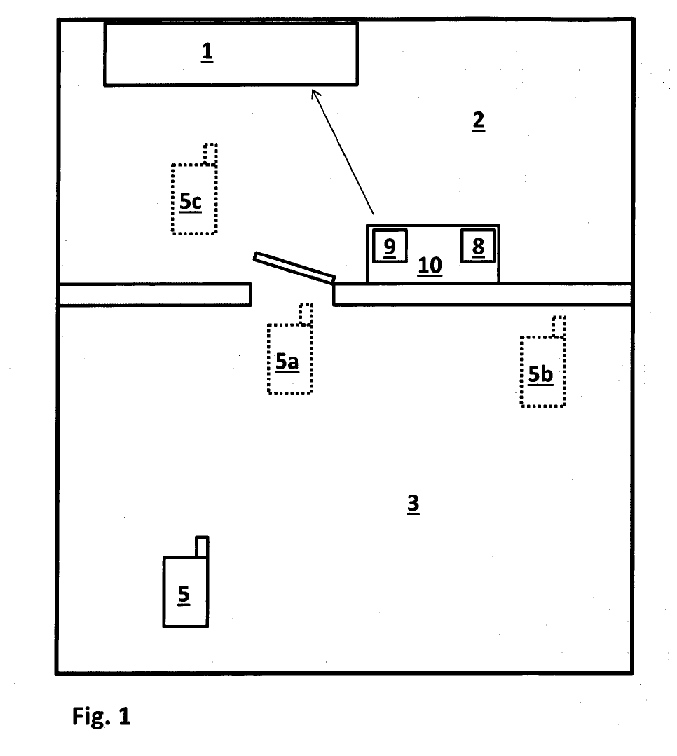

FIG. 1 shows, schematically, two adjacent rooms 2 and 3. In room 2 there is an air conditioning system 1. Also in room 2 there is a control apparatus 10 according to the invention for the remote control of the air conditioning system 1.

The control apparatus 10 comprises a casing with mechanical assembly means, through which an assembly at, in principle, any desired location relative to the air conditioning system 1 to be controlled is possible. It is thereby necessary for a communication from the control apparatus 10 to the air conditioning system 1 to be possible.

For this, the control apparatus 10 comprises a sending device 9, which can send air conditioning system control commands (AC control commands). These can be for example radio or infrared signals and are illustrated in the FIGURE by the arrow to the air conditioning system 1.

If the air conditioning system 1 receives such an AC control command, it changes its operating state accordingly. Possible operating states can be, for example, switched-on and switched-off, different reference temperatures and/or ventilation strengths.

The control apparatus 10 is to allow a remote control, for which a user does not have to be present at the control apparatus 10, in particular a user does not have to activate any keys on the control apparatus 10. Instead, the control apparatus 10 comprises electronic signal receiving means 8. These can include for example network communication means, for example a WLAN transmitter.

The signal receiving means 8 can receive instructions for the air conditioning system control. In dependence thereon, the sending device 9 sends an AC control command to the air conditioning system 1.

If a user is not in the room 2, he cannot check whether the air conditioning system 1 is in a desired operating state and has implemented an AC control command of the control apparatus 10 as desired.

Depending on the model of the air conditioning system 1, it may be that it also does not send a command receipt signal back to the control apparatus 10. The control apparatus 10 cannot thereby readily check whether the air conditioning system 1 is working in the desired operating state.

This leads to the risk of the air conditioning system 1 cooling unnecessarily intensely or being switched on for unnecessarily long periods, which is associated with excessive energy consumption. In the case of insufficient cooling, which is also possible, on the other hand the comfort of the user is reduced.

Here, the design according to the invention of the control apparatus 10 provides a remedy. It comprises measuring means, with which an ambient property in the room 2 can be determined. Based on the ambient property determined, control and evaluation means of the control apparatus 10 can infer whether an operating state has been changed and/or whether a desired operating state has been adopted. If this is not the case, the AC control command is re-sent and it is checked in turn whether a change in the ambient property then occurs.

Through the invention, the reliability of operating an air conditioning system 1 in the desired operating state is increased without an intervention by the user being necessary.

The measured ambient property can be any physical variable that changes during the operation of the air conditioning system 1 and/or during operating state change of the air conditioning system 1. This is the case for example with the room temperature or the relative air humidity in the room 2. Ambient sound can also be measured as an ambient property. For example, the sound emissions of the air conditioning system 1 generally increase as the cooling intensity becomes greater. Depending on the air conditioning system model it may also be that an acoustic indicator, for example a beep, is sent as a command receipt confirmation of an AC control command. The measuring means can measure (or detect) this acoustic indicator and thus check whether the AC control command has been received.

Instructions for the air conditioning system control can be obtained by the control apparatus 10 for example from a network server. This in turn receives information or instructions from a smartphone 5 carried by a user, who may be in the room 2 or outside of the room 2. Alternatively or additionally, it can also be provided that the smartphone 5 can send instructions for the air conditioning system control or other information directly to the control apparatus 10. For this, program code is provided, which can be run on the smartphone 5.

If the user of the smartphone 5 is outside of the building, in which the room 2 is situated, this can be determined relatively simply. For example, GPS localization means, WLAN or mobile radio device of the smartphone 5 can be used for position determination. The determined position can be transmitted from the smartphone 5 to the network server, which, depending on this position, sends instructions for the air conditioning system control to the control apparatus 10. Such instructions can also be generated directly by the smartphone and sent to the network server or also directly to the control apparatus 10.

Indoor localizations are more difficult than these outdoor localizations, wherein, in the former case, the position of the smartphone 5 within a building has to be determined. For example, the air conditioning system 1 is not to be operated, or is only to be operated with a low cooling power, if the user of the smartphone 5 is in the room 3, as shown in FIG. 1. If on the other hand the smartphone is in the position 5c, shown in broken lines, i.e. in the room 2 of the air conditioning system 1, the air conditioning system 1 is to be switched on or operated with greater cooling power. For such localizations, GPS localization means, WLAN or wireless transmission device are often insufficient. Therefore, a relative distance of the smartphone 5 from the control apparatus 10 is determined. The latter thus includes a radio device that emits a radio signal. The radio signal is received by the smartphone 5 and analysed in particular with respect to the signal strength in order to estimate a distance from the control apparatus 10. In dependence on the distance thus determined, the smartphone sends instructions for the air conditioning system control.

In order to improve the reliability of this distance determination, program code to be run on the smartphone can also be designed to provide a location teaching mode. In this mode, a user takes the smartphone to different locations, at each of which a distance from the control apparatus is determined, as described above. The user additionally indicates which instruction for the air conditioning system control is to be sent if this learned location is detected in a normal mode. In this way, the locations 5a and 5b, shown in broken lines in the drawing, for example, can be differentiated. The distance of the smartphone from the control apparatus is approximately the same in these two cases. At the location 5a, however, the smartphone is at the door to the room 2 with the control apparatus 10. Due to the fact that the door weakens the radio signal differently from, or less than, a wall of the room, this position can be differentiated from the location 5b. The user can indicate for example in the location teaching mode that, in the case of a distance determination corresponding to the location 5a, the air conditioning system is to be operated more intensely than in the case of a distance determination corresponding to the location 5b.

Further checking mechanisms can be provided in order to check whether a user is in the room 2 of the air conditioning system 1. The control apparatus 10 can contain a motion sensor or, for example, detect sounds caused by the user and infer therefrom the presence of the user.

Through the control apparatus according to the invention and the system according to the invention, an air conditioning system can be controlled with extensive automation and particular reliability. In addition to great user comfort, the energy consumption of the air conditioning system is kept low.

1. A control apparatus for remote controlling an air conditioning system, comprising:
a sending device for sending an air conditioning system control command,
an electronic signal receiving device for receiving instructions for air conditioning system control, and
an electronic control and evaluation device, which is configured, in dependence on received instructions for the air conditioning system control, to trigger the sending device to send an air conditioning system control command,
a measuring device for determining at least one ambient property,
wherein the electronic control and evaluation device is additionally configured:
using measurement values of the measuring device, to evaluate whether, after sending of an air conditioning system control command, a change has occurred in the ambient property measured, and
to re-send an air conditioning system control command if the evaluation reveals that no change has arisen in the measured ambient property.

2. The control apparatus according to claim 1,
wherein:
the measuring device is configured to detect, as an ambient property, at least one of: an ambient temperature, ambient noise, or a relative air humidity.

3. The control apparatus according to claim 1,
wherein:
the electronic control and evaluation device is additionally configured:
upon receiving an instruction for the air conditioning system control, to acquire measurement values of an ambient property with the measuring device,
then to send an air conditioning control command with the sending device,
to then re-acquire measurement values of the ambient property with the measuring device and
using the measurement values recorded before and after sending of the air conditioning control command, to carry out an evaluation to establish whether, after sending of an air conditioning system control command, a change has occurred in the measured ambient property.

4. The control apparatus according to claim 1,
wherein:
the electronic control and evaluation device is additionally configured:
to execute a teaching mode, in which an ambient property is measured with the measuring device before an air conditioning system control command is sent and after it has been sent, and
to use measurement values of the ambient property from the teaching mode in a normal mode in the evaluation to establish whether, after sending an air conditioning system control command, a change has arisen in the measured ambient property.

5. The control apparatus according to claim 1,
wherein:
the electronic control and evaluation device is additionally configured:
using the measurement values of the measuring device, to determine an operating state of the air conditioning system, and
the electronic control and evaluation device further comprises a communication device configured to transmit a determined operating state over a network.

6. The control apparatus according to claim 1,
wherein:
the electronic control and evaluation device is additionally configured:
to transmit a transmission error message over a network with a communication device if a change in the ambient property has still not been determined after repeatedly sending the same air conditioning system control command.

7. The control apparatus according to claim 1,
wherein:
the electronic control and evaluation device is configured, after sending of an air conditioning system control command, to carry out a checking process to check whether a user is actually in proximity to the air conditioning system, and in the checking process:
the measuring device records ambient sound, which is then analysed by the electronic control and evaluation device to establish whether it contains sounds caused by the user, and
a further air conditioning system control command, through which the last sent air conditioning system control command is cancelled, is sent in dependence on whether sounds caused by the user are ascertained.

8. The control apparatus according to claim 7,
wherein:
the checking process is carried out at a time between 10 seconds and 5 minutes after sending of the air conditioning system control command to activate or turn up the air conditioning system.

9. The control apparatus according to claim 1,
wherein:
the electronic control and evaluation device is configured, before sending of an air conditioning system control command, to carry out a checking process to check whether a user is actually in proximity to the air conditioning system, and
in the checking process:
the measuring device records ambient sound, which is then analysed by the electronic control and evaluation device to establish whether it contains sounds caused by the user, and
the air conditioning system control command is sent in dependence on whether sounds caused by the user are ascertained.

10. A system for remote controlling an air conditioning system, comprising
a control apparatus according to claim 1, wherein the control apparatus has a radio device for sending a radio signal, and
program code, which is stored on a data carrier readable by a smartphone, and which is configured, when run on a smartphone:
to analyse a radio signal sent by the radio device and received by the smartphone and to thus determine location information of the smartphone relative to the control apparatus, and
in dependence on the location information, to send an instruction for the air conditioning system control to the control apparatus.

11. The system according to claim 10,
wherein:
a signal strength of a network can be detected with the communication device of the control device,
the program code is designed, when run on a smartphone, to cause the smartphone to detect a signal strength of the network,
a determination of the location information of the smartphone is realised not only through the analysis of the radio signal, but additionally by an electronic evaluation device which is configured, through a comparison of the signal strength detected with the communication device of the control apparatus, and the signal strength detected by the smartphone, to estimate a distance between the two.

12. The system according to claim 10,
wherein:
the program code provides a location teaching mode and a normal mode,
in the location teaching mode, a user of the smartphone is given the opportunity, at different locations:
a) to trigger the program code to carry out a location determination at the respective location and to store location information recorded in this way, and
b) at the respective location, to indicate which type of instruction for the air conditioning system control is to be sent from the smartphone to the control apparatus,
in the normal mode, an analysis of a radio signal is carried out to determine momentary location information of the smartphone by matching with the recorded location information from the location teaching mode being determined, and
the type of instruction for the air conditioning system control, which was stored in the location teaching mode with the matching location information, is sent to the control apparatus.

13. The system according to claim 10,
wherein:
a data memory is provided, in which different sets of air conditioning system control commands are stored to control different types of air conditioning systems,
the program code provides a control command selection mode, in which a user can trigger sending of air conditioning system control commands of different sets and in which, after sending of each of the air conditioning system control commands, the user can input via the smartphone or the measuring device determine by measuring the ambient property whether an operating state of the air conditioning system has changed corresponding to the air conditioning system control command sent.

14. The system according to claim 10,
wherein:
the program code is designed to trigger, in the checking process in which the actual proximity of the user to the air conditioning system is checked, the microphone of the smartphone to record ambient sound, and
for checking a proximity of the user to the air conditioning system, a match between ambient sound recorded by the smartphone and ambient sound recording by the measuring device is determined.

15. A method for remote controlling an air conditioning system,
wherein:
a sending device of a control apparatus sends an air conditioning system control command,
electronic signal receiving device of the control apparatus receives instructions for the air conditioning system control and
electronic control and evaluation device of the control apparatus, in dependence on received instructions for the air conditioning system control, triggers the sending device to send an air conditioning system control command,
wherein:
a measuring device of the control apparatus determines at least one ambient property, and
the electronic control and evaluation device:
evaluates using measurement values of the measuring means, whether, after sending of an air conditioning system control command, a change has taken place in the measured ambient property, and
resends an air conditioning system control command if the evaluation reveals that no change in the measured ambient property has arisen.
